(19) United States
(12) Patent Application Publication
(10) Pub. No.: US 2026/0051827 A1
(43) Pub. Date: Feb. 19, 2026

(54) ENERGY CONVERSION DEVICE WITH INTEGRATED ACTIVE CELL BALANCING

(71) Applicant: Enphase Energy, Inc., Petaluma, CA (US)

(72) Inventor: Michael J. HARRISON, Petaluma, CA (US)

(21) Appl. No.: 19/292,441

(22) Filed: Aug. 6, 2025

Related U.S. Application Data
(60) Provisional application No. 63/684,663, filed on Aug. 19, 2024.

(51) Int. Cl. H02M 7/162; H02J 7/00; H02M 1/00; H02M 1/38; H02M 7/04

(52) U.S. Cl. CPC H02M 7/162; H02J 7/0019; H02M 1/0043; H02M 1/38; H02M 7/043; H02J 2207/20

(57) ABSTRACT

An energy conversion device with an integrated active cell balancing circuit. The energy conversion device comprising a cell balancing circuit adapted to be connected to a plurality of cells of a battery, where the cell balancing circuit forms a DC bridge. A transformer, having a primary winding forming a portion of the cell balancing circuit, couples energy to a secondary winding. The secondary winding forms a portion of a resonant cycloconverter configured to convert the coupled energy to an AC output.

### RELATED APPLICATION

This application claims benefit to U.S. Provisional Patent Application Ser. No. 63/684,663, filed 18 Aug. 2024, entitled “Energy Conversion Device with Integrated Active Cell Balancing,” which is hereby incorporated herein by reference in its entirety.

### BACKGROUND

### Field

Embodiments of the present invention generally relate to energy conversion devices and, more specifically, to an energy conversion device with integrated active cell balancing.

### Description of the Related Art

Battery energy storage systems (BESS) generally comprise a battery formed of a plurality of battery cells, an energy conversion device or devices and a battery management unit (BMU). The BMU controls battery charging and discharging via the energy conversion device(s). The energy conversion device(s) are typically at least one DC/AC bidirectional microinverters that convert stored DC power to AC power to discharge the battery and convert AC power to DC power to charge the battery.

The battery is typically manufactured using series connected strings of lithium-ion cells. Unfortunately, lithium-ion cells are subject to thermal runaway that can lead to a fire within the battery. To reduce the probability of thermal runaway, the battery requires the cell voltages to be balanced across all the cells. Balancing is typically performed by a cell balancing circuit.

Balancing circuits may be either passive or active. Passive balancing circuits typically comprise a field effect transistor (FET) coupled across the terminals of each cell. The FET operates as a variable load such that higher voltage cells are loaded to reduce the cell voltage. This results in the cell voltages being adjusted to match the cell with the lowest voltage. There is no mechanism for increasing the voltage on low voltage cells. Consequently, passive balancing circuits are inefficient.

Furthermore, active balancing circuits generally require constant monitoring of the state of charge (SoC) of each battery cell. Such monitoring creates a large computational burden that is typically performed by the BMU. This computational burden increases costs and energy use.

Active balancing circuits use complex and expensive circuitry to divert energy from high voltage cells to low voltage cells to balance the cell voltages. Such circuits require monitoring of the cell voltages and a control circuit to control the flow of energy from cell to cell. Such monitoring and control creates a large computational burden that is typically performed by the BMU. This computational burden increases costs and energy use.

In all cases, the energy conversion device and the cell balancing circuit are separate devices that operate independently of one another. Such independent circuitry may include redundant components that add cost and inefficiency.

Therefore, there is a need in the art for an energy conversion device with an integrated active cell balancing circuit.

### SUMMARY

An energy conversion device with integrated active cell balancing is provided substantially as shown in and/or described in connection with at least one of the figures, as set forth more completely in the claims.

Various features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the various features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of an energy conversion device with an integrated active cell balancing circuit in accordance with at least one embodiment of the invention;

FIG. 2 is a block diagram of a controller for controlling the energy conversion device of FIG. 1 in accordance with at least one embodiment of the invention;

FIG. 3 is a schematic diagram of an energy conversion device with an integrated active cell balancing circuit in accordance with at least one alternative embodiment of the invention; and

FIG. 4 is a flow diagram of a method of controlling the energy conversion device of FIG. 1 or 3 in accordance with at least one embodiment of the invention.

### DETAILED DESCRIPTION

Embodiments of the invention provide methods and apparatus that facilitate energy conversion with integrated active cell balancing for a battery in a battery energy storage system (BESS). The embodiments include active balancing circuitry as well as various methods controlling the circuitry.

In one embodiment, a cell balancing circuit comprises a series connected inductor and field effect transistor (FET) connected across each battery cell in a multi-cell battery. In one exemplary embodiment, the inductor is implemented as a winding in a stacked planar transformer that uses a single core for all the windings. The cell balancing circuit forms a DC bridge of the energy conversion device where the cell balancing circuit transformer forms the primary winding of the energy conversion device (e.g., a resonant cycloconverter-based microinverter). A secondary winding couples energy from the primary winding to a resonant cycloconverter (i.e., an AC-AC converter). In this manner, all the cells are inductively coupled to one another and to the resonant cycloconverter. The DC bridge/cell balancer FETs are activated on a 50% duty cycle with the FET for alternating cells being on while other FETs are off, i.e., neighboring cell FETs alternate being on (conducting) or off (not conducting). To avoid hard switching losses, there is a small dead time at the transition from on to off and vice versa to implement zero volt switched (ZVS) commutation. The energy coupled to the cycloconverter is then switched to form an AC output.

Embodiments of the invention may be used during both discharging and charging of the battery, i.e., the energy conversion device is bidirectional. By connecting a transformer winding across all the cells, the transformer automatically balances the voltages across the cells-weak cells receive additional charge and strong cells have charge removed.

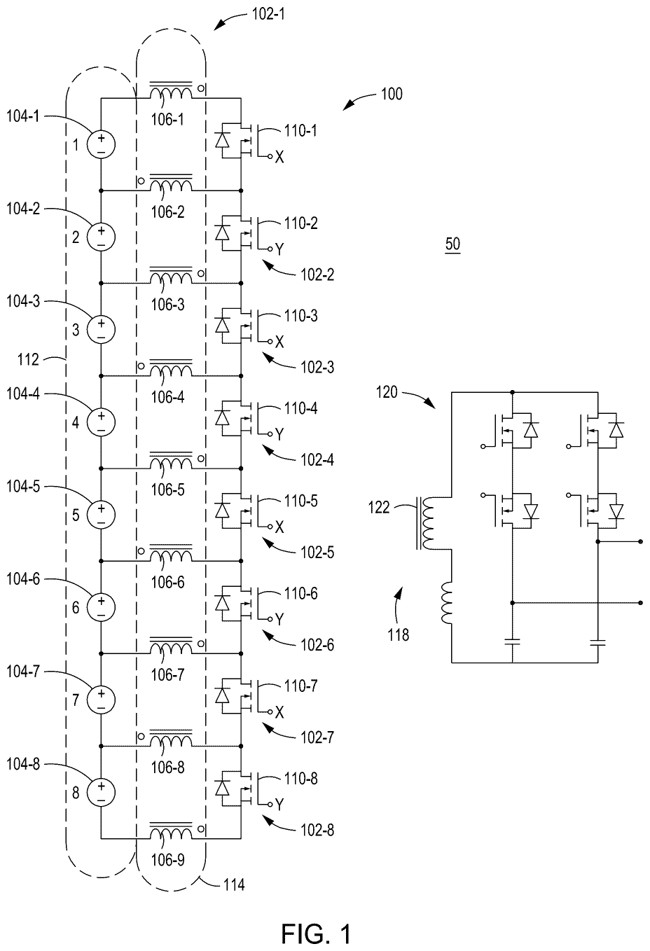

FIG. 1 is a schematic diagram of an energy conversion device 50 with an active cell balancing circuit 100 in accordance with at least one embodiment of the present invention. More specifically, the energy conversion device 50 comprises an active cell balancing circuit 100 that also operates as a DC bridge of the energy conversion device 50. The DC bridge (circuit 100) is coupled via a transformer 118 to a resonant cycloconverter 120. The DC bridge converts the battery DC power to a high-frequency AC power, while the cycloconverter converts the high-frequency AC power to a line frequency AC power (e.g., 50/60 Hz).

More specifically, the circuit 100 comprises a plurality of balancing circuits 102-1, 102-2, 102-3 . . . 102-N connected across each battery cell 104-1, 104-2, 104-3 . . . 104-N. The balancing circuit 102-1 comprises first and second inductors 106-1 and 106-2 and a field effect transistor 110-1 connected in series. The series connection is made with a first terminal of first inductor 106-1 being coupled to one cell terminal (e.g., positive) of cell 104-1 and a second terminal of the first inductor 106-1 being coupled to a drain terminal of the FET 110-1. Similarly, a first terminal of the second inductor 106-2 is connected to the other cell terminal (e.g., negative) of cell 104-1 and a second terminal of the second inductor 106-2 is connected to the source terminal of the FET 110-1. In addition, the second terminal of the second inductor 106-2 is connected to the drain terminal of the neighboring (adjacent) FET 110-2. In this manner each balancing circuit 102-N comprises two inductors 106-N and 106-N+1 connected in series with a FET 110-N. Each circuit 102-N shares an inductor with a neighboring (adjacent) balancing circuit 102-N±1.

The circuit 102-N is duplicated across each cell 104-N in the battery 112. Each circuit 102-N shares an inductor (e.g., 106-N) with a neighboring (adjacent) circuit 102-N±1. The depicted embodiment comprises eight cells (numbered 1 through 8) coupled to 8 balancing circuits 102-1 through 102-8. In other embodiments, more or less cells may be used. In the embodiment shown, the cells 104-N are connected in series to provide a high voltage, low current battery output. In other embodiments, the cells may be connected in parallel to create a high current, low voltage battery. In some embodiments, some cells may be connected in parallel, and the parallel connected cells may be connected in series with other parallel connected cells.

The inductors 106-N in adjacent circuits 102-N and 102-N±1 are wound in opposite directions (as indicated by the dot next to each inductor drawing to indicate the direction of winding) onto a common core to form a transformer 114 (i.e., a stacked transformer) that couples energy from cell to cell. The counter-wound windings of each inductor circumscribe the common core (represented by the parallel lines next to each inductor 106-N in FIG. 1). Consequently, during charging of the battery 112, charge will flow from “weak” cells to “healthy” cells and, during discharging of the battery, charge flows from “healthy” cells to “weak” cells. Healthy cells have cell voltages equal to or greater than a nominal cell voltage, while weak cells have a cell voltage below the nominal voltage. In this embodiment, the balancing function occurs automatically without the need to monitor individual cell voltages.

To achieve cell balance, the gates of each FET 110-N are switched in an alternating pattern, i.e., when all the X gates are “on” and all the Y gates are “off” and vice versa. Such switching results in a 50% duty cycle. The concept relies upon the inherent volt-second balancing inherent with any inductor/transformer 114 to keep the cell voltages balanced (i.e., the +ve volt-second integral=the −ve volt-second integral). With each switching cycle, a pair of counter-wound transformer coils (indictors) are coupled across every other cell in the battery. The transformer action maintains the cell voltage balanced (i.e., each winding voltage must be equal). Consequently, during charging of the battery, more charge flows from “weak” cells (cells having comparatively lower voltage) to “healthy” cells (cells having comparatively higher voltage) and, during discharging of the battery, more charge flows from “healthy” cells to “weak” cells.

The active cell balancing circuit 100 works based on the following theory:
1) The X Gates and Y Gates are driven with a 50:50 two phase clock signal (180° phase difference between X and Y gates);
2) There is a small ‘dead-time’ used at the transitions (both X and Y gates are off)—during this dead-time the naturally occurring transformer current will drive a Zero-Volt-Switched (ZVS) commutation (eliminating any ‘Hard’ switching losses); and
3) The cell voltages will remain at the same voltage and any imbalance between the apparent capacity of the cells is resolved as differential currents that flow through the transformer windings (inductors 106-N).

In one embodiment, the transformer design is based on well-known planar, printed circuit board (PCB) winding construction techniques:
1) A single core couples the individual windings that are spread over a multi-layer PCB (e.g., 4-layer);
2) From an analysis perspective, the balancing circuit 100 makes the series connected cells 104-N act as if they are connected in parallel;
3) The FETs 110-N only require a voltage rating equal to two times the maximum cell voltage, e.g., 12V FETs will be more than adequate for Li-Ion cells (where Li-Ion maximum voltage =4.2V).

With an active cell balancing circuit 100, there is a design cost optimization that drives to a design of a balancer that only processes a fraction of the total battery current. Such a design can extend the usable service life that can be extracted out of a battery to a maximum but requires the active cell balancing circuit 100 being sized so that it can process the total battery current. This allows the battery to still deliver full output voltage and current even with some completely ‘dead’ cells. However, it is statistically improbable to have a battery which has some cells completely ‘dead’ while others have the ‘health’ of a brand-new cell. Statistically, it is expected that all the cells of a battery deteriorate at substantially the same rate. There are diminishing returns when increasing the power rating of the balancing circuit versus the additional service life that can be extracted from the battery.

The design philosophy for cell balancing circuit 100 is:
1) The total cell balancing circuit power rating equals maximum charge/discharge power rating;
2) Cells will never become imbalanced during charging and discharging;
3) During charging: all cells (weak and strong) are fully charged by applying the appropriate charge rate to each individual cell;
4) During discharging: all cells (weak and strong) are fully discharged by applying the appropriate discharge rate to each individual cell;
5) A cell ‘balancing’ algorithm is managing the balancing hardware to ensure it transferring sufficient power to ensure that cell imbalance will not ever start to occur in the first place;
6) The cell balancing hardware works on the basis of ensuring that cell voltage imbalance is never allowed to occur during charging and discharging; and
7) A special ‘Recovery Mode’ allows the initial balancing of a battery during commissioning, i.e., the cell balancing circuit should be made inoperable during transportation of a battery product.

Overall battery performance is determined by the average performance of all the cells 104-N in the battery 112. The cell balancing circuit 100 optimally manages all the cells 104-N in the battery 112.

The inductors 106/108 (cell balancing transformer 114) form the primary winding of the energy conversion device transformer 118 to couple energy to the resonant cycloconverter 120 via secondary winding 122. The DC bridge (balancing circuit 100) converts DC power to AC power, while the cycloconverter 120 performs an AC-to-AC conversion to output AC power at power line frequencies, e.g., 50/60 Hz.

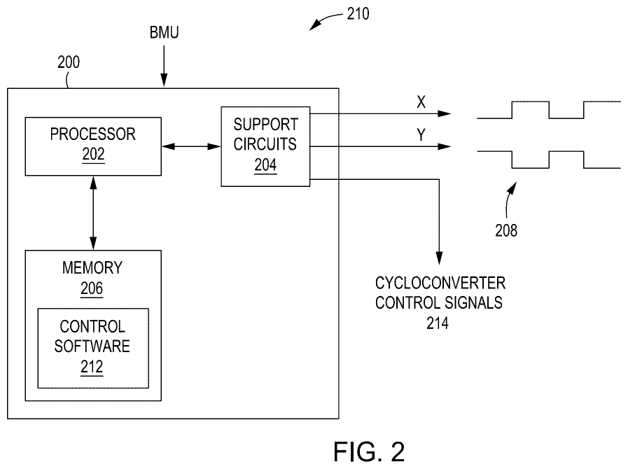

FIG. 2 is a block diagram of a controller 200 for controlling the energy conversion device 50 of FIG. 1 in accordance with at least one embodiment of the present invention. The controller 200 provides the switching signals to the cell balancing circuit 100 of FIG. 1. The controller 200 comprises at least one processor 202, support circuits 204 and memory 206. The at least one processor 202 may be any form of processor or combination of processors including, but not limited to, central processing units, microprocessors, microcontrollers, field programmable gate arrays, graphics processing units, and the like. The support circuits 204 may comprise well-known circuits and devices facilitating functionality of the processor(s). The support circuits 204 may comprise one or more of, or a combination of, power supplies, clock circuits, communications circuits, cache, gate drivers, and/or the like.

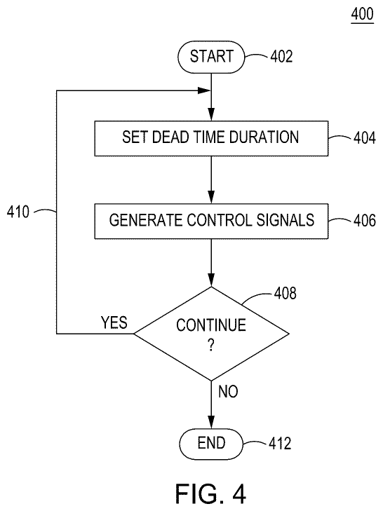

The memory 206 comprises one or more forms of non-transitory computer readable media including one or more of, or any combination of, read-only memory or random-access memory. The memory 206 stores software and data including, for example control software 212 that, when executed by the processor 202, causes the controller 200 to produce the 180 degree out of phase X and Y gate control signals 208. The control software may also control the duration of the “dead” time that occurs at the zero crossing of the switching. In one embodiment, timing of when the controller 200 activates the balancing circuit may be controlled by a signal 210 from the battery management unit (BMU). The BMU may maintain the balancing circuit in an off state (deactivated) during shipping. In addition, the BMU may control activation of the balancing circuit depending on the state of health (SoH) of the battery, i.e., a new battery may not need the balancing circuit until the cells age and are cycled over a period. At a certain level of SoH, the BMU may activate the balancing circuit. Operation of the control software 212 is described in detail with respect to FIG. 4.

The control software 212 may also generate cycloconverter control signals 214. These control signals 214 control the switching of the FETs in the cycloconverter to facilitate AC power conversion in a manner that is well known in the art.

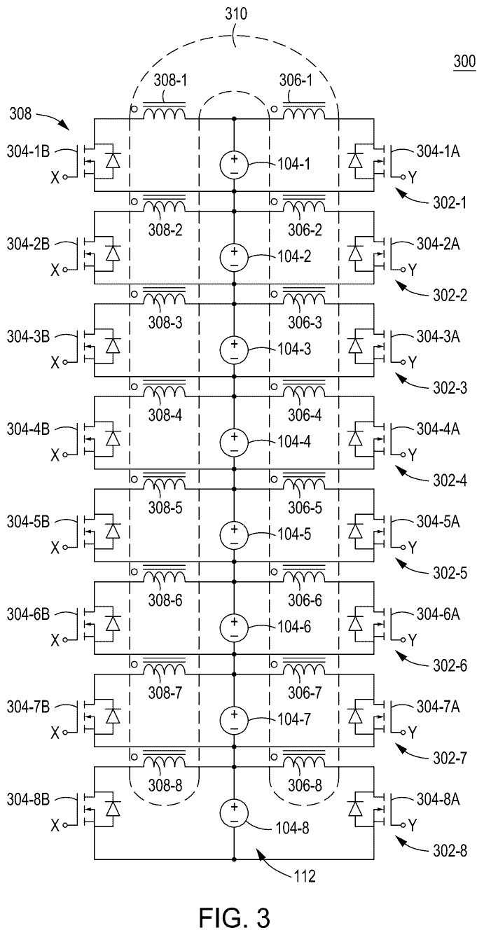

FIG. 3 is a schematic diagram of an active cell balancing circuit 300 in accordance with at least one alternative embodiment of the present invention. In this embodiment, the number of FETs 304 and inductors 306 and 308 in the transformer 310 are doubled compared to the embodiment of FIG. 1. The added complexity reduces ripple current and facilitates the use of a gapless transformer, i.e., the transformer does not need to store any energy. In this embodiment, each cell 104-N of the battery 112 is coupled to a balancing circuit 302-1, 302-2, 302-3 . . . 302-N. Each balancing circuit 302-N comprises a first FET 302-NA (where N is an integer 1, 2, 3, . . . . N) and a first inductor 306-NA (where N is an integer 1, 2, 3, . . . . N) connected in series and connected across the terminals of a battery cell 104-N. Additionally, a second FET 304-NB and a second inductor 308-1 are connected in series and also connected across the terminals of the cell 104-N (e.g., the inductors are connected to the positive terminal of the cell and the source terminals of each FET are connected to the negative terminal of the cell). This arrangement is repeated for each cell 104-N of the battery 112. The inductors 306-N and 308-N are wound on a common core to produce a transformer 310.

As with the embodiment of FIG. 1, the X gate of FET 304-NB and the Y gate of FET 304-NA are driven by a 180 degrees out of phase switching signal that turns all the X gates “on” when the Y gates are “off” and vice versa—with dead zones at the switching point. Consequently, the embodiment of FIG. 3 operates in the same manner as the embodiment of FIG. 1. However, this embodiment eliminates the dependance on using volt-second integral balancing provided by the inductive nature of the transformer. As a result, no energy needs to be stored in the transformer and the transformer can, therefore, be gapless which reduces the magnitude of the ripple current.

FIG. 4 is a flow diagram of a method 400 of controlling the active cell balancing circuits 102 and 302 of FIG. 1 or 3 in accordance with at least one embodiment of the present invention. The method 400 starts at 402. As mentioned above, the activation of the balancing circuit may be controlled by the BMU to selectively activate the balancing circuit as needed. The method 400 proceeds from 402 to 404 where the dead time durations are established. During the dead time, both X and Y FETs are off (deactivated) to establish zero volt switching (ZVS) commutations. The dead time duration is actively managed to avoid partial hard switching when the dead time is too short or excessive FET body diode conduction when the dead time is too long. The optimum dead time duration may vary with battery cell voltage and current. The dead time duration may vary from a fraction of a percent up to about ten percent of the total switching period. For example, when using silicon MOSFETs, the ZVS dead time may range from a few tens of nanoseconds to a few hundreds of nanoseconds. When using GaN HEMT FETs, the ZVS dead time will be on the order of a few nanoseconds to a few tens of nanoseconds. As such, the switching frequency of the control signals may be adjusted to change the ZVS commutation current.

At 406, the method 400 generates the control signals using the dead time duration established in 404 (e.g., set the switching frequency of each signal). The control signals are 180 degrees out of phase with one another to ensure the X and Y gates are alternatingly activated. The switching frequency depends upon the FET-type used in the balancing circuit. For example, when using silicon MOSFETs, the switching frequency may be on the order of a few tens of kilohertz to a few hundreds of kilohertz. When using GaN HEMT FETs, the switching frequency may be on the order of a few hundreds of kilohertz to a few megahertz.

At 408, the method 400 queries if the method should continue. If the query is affirmatively answered, the method 400 continues along path 410 to 404 where the dead time durations are established. In this manner, after each control signal pulse, the dead time duration may be changed to optimize the duration. In other embodiments, the dead time duration may not be dynamic and may be established at start-up and remain the same. If the query at 408 is negatively answered, the method 400 proceeds to 412 and ends.

Here multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. An energy conversion device comprising:
a cell balancing circuit adapted to be connected to a plurality of cells of a battery, where the cell balancing circuit forms a DC bridge;
a transformer having a primary winding forming a portion of the cell balancing circuit that couples energy to a secondary winding; and
a resonant cycloconverter comprising the secondary winding configured to convert the energy that is coupled from the primary winding to the secondary winding into an AC output.

2. The energy conversion device of claim 1 wherein the transformer comprises a plurality of stacked inductors circumscribing a common core and wherein the active cell balancing circuit comprises a plurality of balancing circuits, where each balancing circuit comprises a transistor coupled in series with a first inductor and second inductor of the plurality of stacked inductors, and where each balancing circuit is connected across a battery cell.

3. The energy conversion device of claim 2 further comprising:
a controller for controlling each transistor in each balancing circuit such that transistors within adjacent balancing circuits are alternately activated and deactivated.

4. The energy conversion device of claim 3 wherein alternating activation and deactivation is produced by driving each transistor with a 50% duty cycle switching signal that is 180 degrees out of phase with a switching signal applied to an adjacent transistor.

5. The energy conversion device of claim 4 wherein adjacent switching signals comprise a dead time where neither adjacent transistor is activated.

6. The energy conversion device of claim 1 wherein cell balancing occurs during battery charging and discharging.

7. The energy conversion device of claim 1 wherein the first and second inductors are oppositely wound.

8. The energy conversion device of claim 1 wherein during charging of the battery, charge flows from weak cells to healthy cells and, during discharging of the battery, charge flows from healthy cells to weak cells.

9. The energy conversion device of claim 2 wherein adjacent balancing circuits share either the first or second inductor.

10. The energy conversion device of claim 1 wherein the plurality of cells are connected in series, parallel or both.

11. The energy conversion device of claim 1 wherein the transformer having a plurality of stacked inductors circumscribing a common core and wherein the active cell balancing circuit comprises a plurality of balancing circuits, where each balancing circuit comprises a first transistor coupled in series with a first inductor of the plurality of stacked inductors and a second transistor coupled in series with a second inductor, and where each series connected transistor and inductor is connected across a battery cell.

12. The energy conversion device of claim 11 further comprising:
a controller for controlling the first and second transistors in each balancing circuit such that the first and second transistors are alternately activated and deactivated.

13. The energy conversion device of claim 12 wherein alternating activation and deactivation is produced by driving the first and second transistors with a 50% duty cycle switching signal, where the switching signal applied to the first transistor is 180 degrees out of phase with a switching signal applied to the second transistor.

14. The energy conversion device of claim 13 wherein the two switching signals comprise a dead time where neither transistor is activated.

15. The energy conversion device of claim 11 wherein cell balancing occurs during battery charging and discharging.

16. The energy conversion device of claim 11 wherein during charging of the battery, charge flows from weak cells to healthy cells and, during discharging of the battery, charge flows from healthy cells to weak cells.

17. The energy conversion device of claim 11 wherein the plurality of cells are connected in series, parallel or both.

18. A method of controlling an energy conversion device, the energy conversion device comprises a plurality of balancing circuits, where each balancing circuit is coupled to a cell of a battery and each balancing circuit is magnetically coupled to a resonant cycloconverter, the method comprising:
controlling each balancing circuit such that adjacent balancing circuits are alternately activated and deactivated.

19. The method of claim 18 wherein alternating activation and deactivation is produced by driving each balancing circuit with a 50% duty cycle switching signal that is 180 degrees out of phase with a switching signal applied to an adjacent balancing circuit.

20. The method of claim 19 wherein adjacent switching signals comprise a dead time where neither adjacent balancing circuit is activated.
